(19) United States
(12) Patent Application Publication
(10) Pub. No.: US 2011/0265004 A1
(43) Pub. Date: Oct. 27, 2011

(54) Interactive Media Device and Method

(76) Inventor: Anthony G. Sitko, Harbor Springs, MI (US)

(21) Appl. No.: 12/766,875

(22) Filed: Apr. 24, 2010

(51) Int. Cl. G06F 3/01; G10L 15/26

(52) U.S. Cl. 715/730; 704/235; 704/E15.043

(57) ABSTRACT

An interactive media device and method allows a user to select a format by which stored text of a book or stored audio of a book or combinations thereof are presented to the user. For example, if the user wishes to read the book, the user may select display of the text of a screen for reading. Alternatively, the user may select audio of the text resulting in the text being converted so that audio sound of the text is provided for listening. Interactive book or place marking allows the user via a device interface to mark a place within the book. Upon returning the user may continue from that place, either by reading displayed text or by listening to audio. Place marking, and presentation of the content either visually or audibly may continue, at the user's selection, until the book is completed.

### TECHNICAL FIELD

This patent relates to media devices, and in particular, to media devices and applications for media devices to present visual or audio entertainment to a user.

### BACKGROUND

Digital technology allows one to store music, books and more on small, multi-function devices such as, without limitation, the Apple, Inc. iPod, iPhone or iPad; the Amazon Kindle; personal computers; laptop computers; netbook computers; personal digital assistants, cell phones, and the like. All sorts of devices exist that can store entertainment content.

The contents of books are a popular media stored on these portable devices. The iPad, Kindle, etc, allow many books to be stored and the contents displayed on a screen for the user to read. Books may also be stored in audio format to be played to the user. In audio format, the book is read by a professional reader, the author or another person or persons, and the spoken audio is stored as a suitable compressed media file. The media file is processed by the device to generate audio via coupled speakers to which the user listens.

Applications for many of these devices allow for voice synthesis of textual material so that the voice synthesized text may be played audibly to the user instead of the user having to read the text from a display. Such applications are popular attachments to email programs to allow the reading of email messages. Other applications, such as Dragon Dictate, accept voice input and through voice recognition technology the spoken input is digitized and converted to text.

### BRIEF DESCRIPTION OF THE DRAWINGS

FIG. 1 is a functional block diagram of an interactive media device in accordance with described embodiments of the invention.

### DETAILED DESCRIPTION

An interactive media device and method allows a user to select a format by which stored text of a book or stored audio of a book or combinations thereof are presented to the user. For example, if the user wishes to read the book, the user may select display of the text of a screen for reading. Alternatively, the user may select audio of the text resulting in the text being converted so that audio sound of the text is provided for listening. Interactive book or place marking allows the user via a device interface to mark a place within the book. Upon returning to the book the user may continue from that place, either by reading displayed text or by listening to audio. Place marking, and presentation of the content either visually or audibly may continue, at the user's selection, until the book is completed.

In an alternative embodiment, the original content may be compressed audio of the text of a book read by a professional reader, author or another person stored on the device. The user may select to listen to the book in audio form, or the user may select to read the book. By selecting reading, the original audio file is converted to text, for example by voice recognition or other device and presented to the user for reading on a display. Place marking allows the user to mark a place in the book and return to that place picking up by listening to the stored audio or reading the converted text, as the user desires.

A description of the workings of devices such as iPads, iPods, iPhones, Kindles, and the like, collectively devices, is not necessary to enable one of ordinary skill in the art to make and use the invention. Device structure and functionality and “App” creation is well documented and supported by the manufacturers of the devices with ample additional documentation, support and assistance being available via Internet, user groups and the manufacturers themselves.

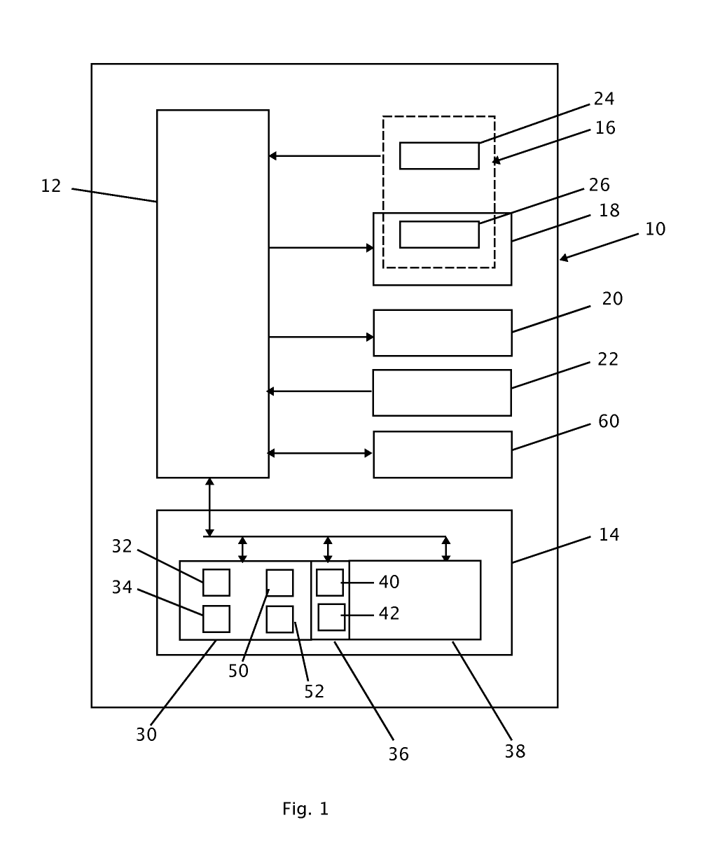

In general, and with reference to FIG. 1, devices such as the device 10 include a processor 12 coupled to a memory 14, one or more user input devices 16, a display 18 and a first sound transducer 20, e.g., a native or coupled speaker(s) and a second sound transducer 22, e.g., a native or coupled microphone(s). The user input device 16 may consist of several elements including one or more hard buttons 24 (one depicted), a touch screen 26 integrated with the display 18 and the second sound transducer 22 to accept voice commands. A user output device may include the display 18 and the first sound transducer 20.

In overview, it is envisioned that the invention will be embodied as an application, i.e., an “App”, a set of processor instructions stored in the memory 14 that may be accessed by the processor 12 to implement the functionality of the invention. In this regard, the processor 12 would access the instructions of the App and process them to retrieve data 38 from the memory 14 representing the stored content of a book in text format, audio format or combinations thereof and present it to the user in the format, displayed text, audio or combinations thereof as selected by the user. The App would also include instructions to allow the processor 12 to store data associated with the data 38 representing the stored content of the book, e.g., a place marker, previous presentation mode data, and the like in the memory 14 either as a separate data file or a data added to the stored content.

The App 30 is stored in the memory 14 of the device 10. The App 30 may include operating instructions 32 and operating parameters 34 stored in the memory 14. Associated with the App 30, there may also be stored status data 36 that relates to particular stored data 38. The stored status data 36 may include place marker data 40, presentation type flag data 42 and other data used by the App 30 to retrieve the stored data 38 and to present the stored data 38 to the user in the manner in which the user wants to receive the stored data 38, i.e., as display text or audio, and from a place within the stored data 38, e.g., from the place where the user last read or listened to the data 38. It should be understood that the stored status data 36 may also or may alternatively be stored with the stored data 38 itself. FIG. 1 shows the stored status data 36 as a separate entity but also optionally tied to the data 38.

A user via the user input device 16, i.e., pressing hard buttons 24, taping touch screen 26 or speaking voice commands via the second sound transducer 22 opens the App 30 within the device 10. Upon opening, the App 30 the processor may cause the presentation of a menu, virtual buttons, reconfigured hard buttons, combinations therefore or the like to allow a user to select stored data 38, i.e., a book, web content, or other content, configure operation of the App 30 on the device 10, set preferences 34 for operation of the App 30 on the device 10, retrieve status data 36 and the like. In this regard, the user is able to provide user selectable presentation data, e.g, set the presentation flag type 42, that identifies to the App 30 the format, text or audio, in which the user wishes the data 38 to be presented on the device 10. Once the user sets operation of the App 30 and/or the processor 12 retrieve data responsive to the App 30, the stored data 38 is presented to the user, as displayed text on the display 18 or as audio via the transducer 20 or as a combination of displayed text and audio.

The first time a user selects stored data 38, the text or audio begins from the beginning of the book or content, unless the user selects otherwise. During reading of displayed text or listening of audio the user may mark a place causing the storing of place marker data 40 in the memory 14. If the user quits the App 30 or uses another functionality of the device 10, e.g., takes a telephone call, sends an email, etc., the App 30 may suspend the presentation of the data 38. In this case it may automatically store place marker data 40, representing wherein the data 38 presentation was suspended and presentation flag data 42, representing how the data last was being presented. On resumption, the App 30 will, unless the user specifies otherwise, present the data 38 from the place designated by the place marker 40 and based upon the presentation flag data 42. That is, if the previous display was text, the App 30 resumes text display and likewise for audio.

In accordance with an embodiment of the invention, the user may select how the data 38 is to be presented regardless of the stored form of the data 38, text or audio. For example, if the data 38 is stored in memory 14 in a text format, the user may select to listen to the data 38. In this case, the presentation flag 42 is set accordingly by the user providing an input via the input device 16. The App 30 may incorporate or the App 30 may link to a voice synthesis engine or other suitable device that is operable to convert the data 38 from text format to audio format for presentation to the user as audio via the first transducer 20. This feature is particularly convenient if the user wishes to enjoy the content of the data 38 but is involved in an activity, e.g., driving an automobile, that prevents reading of the data.

Likewise, if the data 38 is in an audio format, the user may select to read the data 38. In this case, the App 30 again sets the presentation flag accordingly response to the user providing user selectable presentation data via the input device 16. The App 30 may incorporate or link to a voice recognition engine or suitable device to convert the audio data 38 to text for presentation via the display 18.

Thus, the App 30 may be configured to include processor instructions to provide a voice synthesis engine 50 and a voice recognition engine 52. These engines may be instructions integrated into the App 30 (as depicted), or alternatively, the App 30 may link to engines stored elsewhere in the memory 14 or on the device 10, or the App 30 may link to engines via a network. For example, devices such as the iPad include both broadband and WiFi connectivity allowing Internet connection and hence linking to these support functionalities, i.e., engines stored remotely. Generally, the device 10 is shown to include a network interface 60 that may be cellular data network, broadband data network, WiFi, TCP/IP or other suitable interface and network connectivity to allow the device 10 to couple to and communicate via a network.

In one embodiment only a single instance of the data 38 is required to be stored, either text or audio. The App 30 via the engines 50 and 52 can instruct the processor 12 to present the data either as text or audio as selected by the user. The user is also able to mid-stream switch from text to audio and vice-versa by providing user selectable presentation data via the input device 16, which then changes the status of the presentation flag data 42. For example, the user may read a text presentation of the data 38 while riding a train and upon arriving at the station and then transferring to a car continue to enjoy the content of the data 38 by listening to an audio presentation of the data. Upon suspending the presentation of the data 38, whether text presentation or audio presentation, the App 30 updates and stores in the memory 14 the place marker data 40. Upon resumption, the App 30 is able to return to the place in the data 38 at which the user suspended presentation and begin again. Of course, the App 30 may provide skew forward or reverse, page forward or reverse, page or time select or other functionality to allow the user to move within the data 38 to select a starting place for presentation of the data as opposed to sequentially reviewing the data.

The data 38 has been described as audio or text data representing a book. Of course the data 38 may represent other content such as web pages, newspapers, and the like that is generally capable of being represented in text or audio.

The place marker data 40 may be associated with data 38 in its native form. For example, if the data 38 is audio data but the user is reviewing the data as text, the App 30 is processing the audio data to create the text representation data generally in real time. Pre- and post-buffering may be provided to smooth the presentation. Upon suspending review in text form, the place in the audio data is marked, for example by marking a time, a data frame, a data address or the like by the place marker data 40. Upon resumption of review of the data 38 either in text or audio form, the App 30 picks up from the place in the audio data identified by the place marker data 40.

Similarly, if the data 38 is text but the user is reviewing the data as audio, the App 30 is generally processing the text data real time to generate audio via voice synthesis or other suitable text to audio conversion. Pre- and post-buffering may be provided to smooth the presentation. Upon suspending review in audio form, the place in the text data is marked, for example by marking a time, a data frame, a data address or the like by the place marker data 40. Upon resumption of review of the data 38 either in text or audio form, the App 36 picks up from the place in the text data identified by the place marker data 40.

Optionally, the user may select to both read and listen to of the data 38 via configuration of the App 30. The device 10 and App 30 may also be set to automatically select a presentation form based upon the presence or absence of a coupled display or coupled audio interface. For example, if the device 10 is coupled to the audio system of an automobile via well known interfaces, or if headphones or similar external speakers are coupled, the device 10 and App 30 may automatically select audio presentation even if the prior presentation was text. Similarly, even if the prior presentation was audio, the device 10 and App 30 may automatically select text presentation if no external speakers or audio interface is connected.

Thus a device 10 incorporating the App 30 and data 38 provides to the user the convenience of listening to an audio representation or reading a text representation. Generally only one or the other form, i.e., text or audio will be stored in the memory 14 of the device to conserve memory. Thus, a user may load or download a text format book or an audio format book from any number of sources including CD, DVD and online, Internet sources and store the book as data 38 on the device 10. The user may then read, listen to or read and listen to the book via to device 10 and the App 30. The presence of the data 38 in either one of text or audio form allows for the creation and presentation, at the user's election, of corresponding form.

The invention has been described with reference to several potential embodiments. One of skill in the art will appreciate that the invention may be implemented in numerous ways, the described embodiments modified or adapted to other uses or device platforms without such modifications or adaptations departing from the fair scope of the invention has claimed herein. The scope of the invention is not limited by the description of the embodiments herein, but only by the subjoined claims.

I claim:

1. A device comprising:
a user interface, a processor and a memory, the user interface and the memory being coupled to the processor;
the memory containing content data in one of an audio format and a text format, an application for presentation of the content data either as an audio presentation or a text presentation and user selectable presentation data, the user selectable presentation data indicating which of the audio format or the text format the content data shall be presented to the user; and
the processor responsive to instructions contained in the application and a user interface input to access the content data and to present in accordance with the user selectable presentation data the content data in the text format via the user interface when the content data is in the audio format or the content data in the audio format via the user interface when the content data is the text format.

2. The device of claim 1, wherein the user interface comprises a touch screen display and a speaker.

3. The device of claim 1, the memory further comprising place marker data associated with the content data.

4. The device of claim 1, the user selectable presentation data being changeable and the processor being operable in accordance with the application to change a presentation of the content data responsive to a change to the user selectable presentation data.

5. The device of claim 1, the user selectable presentation data including automatic selection presentation data and the processor being operable in accordance with the application to change a presentation of the content data responsive to the automatic selection presentation data to present the content data based upon a configuration of the user interface.

6. The device of claim 1, the application comprising a voice recognition engine and a voice synthesis engine.

7. The device of claim 1, the application being linked via a network to a voice recognition engine and a voice synthesis engine.

8. The device of claim 1, the content data comprising one of a book, a newspaper and a web page.

9. The device of claim 1, the content data having a single format comprising one of an audio format and a text format.

10. A method of presenting content data stored on a device in accordance with a user selectable presentation format data; the method comprising:
retrieving content data from a memory within the device;
determining a format of the content data as either audio format or text format;
determining a presentation format for the content data based upon the user selectable presentation format data;
converting, as necessary the content data from audio format to text format or text format to audio format; and
presenting the content data via a user interface in accordance with the user selectable presentation format data.

11. The method of claim 10, comprising:
retrieving place marker data from the memory;
determining a location within the content data associated with the place marker data; and
presenting the content data via the user interface in accordance with the user selectable presentation format data from the location.

12. The method of claim 10, comprising
receiving second user selectable presentation format data, different than the user selectable presentation format data; and
presenting the content data via a user interface in accordance with the second user selectable presentation format data.

13. The method of claim 10, comprising
automatically selecting either the audio format or the text format for presenting the content data based upon a configuration of the user interface.

14. The method of claim 10, comprising
automatically selecting either the audio format or the text format for presenting the content data based upon a previous user selectable presentation format data.
